(19) United States
(12) Patent Application Publication
(10) Pub. No.: US 2017/0009597 A1
(43) Pub. Date: Jan. 12, 2017

(54) TURBO-MACHINE HAVING A THERMAL TRANSFER LINE

(71) Applicant: SIEMENS AKTIENGESELLSCHAFT, München (DE)

(72) Inventors: Dennis Bensing, Bochum (DE); José Ángel Carvajal Soto, Essen (DE); Bernhard Fischer, Dortmund (DE); Pascal Hoffmann, Düsseldorf (DE); Michael Opheys, Nettetal (DE); Alexander Rambach, Raesfel (DE); Changsheng Xu, Essen (DE)

(73) Assignee: Siemens Aktiengesellschaft, Munich (DE)

(21) Appl. No.: 15/117,879

(22) PCT Filed: Jan. 21, 2015
(86) PCT No.: PCT/EP2015/051111

§ 371 Date: Aug. 10, 2016

(30) Foreign Application Priority Data
Feb. 19, 2014 (DE) 10 2014 203 035.8

(51) Int. Cl. F01D 17/08; G01M 15/14

(52) U.S. Cl. CPC F01D 17/08; G01M 15/14

(57) ABSTRACT

A turbo-machine having a plurality of component slots accessible from the outside, wherein a thermal transfer line is supplied to at least one section of a component slot such that, upon escape of leakage gas out of the section of the component slot, the leakage gas thermally interacts with the thermal transfer line, wherein the thermal transfer line has a plurality of temperature sensors at different locations on the thermal transfer line and the temperature sensors are designed to detect temperature values on the thermal transfer line at the different locations.

### CROSS REFERENCE TO RELATED APPLICATIONS

This application is the US National Stage of International Application No. PCT/EP2015/051111 filed Jan. 21, 2015, and claims the benefit thereof. The International Application claims the benefit of German Application No. DE 102014203035.8 filed Feb. 19, 2014. All of the applications are incorporated by reference herein in their entirety.

### FIELD OF INVENTION

The present invention relates to a turbo-machine having a plurality of component slots accessible from the outside from which leakage gas can escape, wherein the escape of this leakage gas can be detected by sensors. The present invention further relates to a method for operating a turbo-machine of this kind.

### BACKGROUND OF INVENTION

During operation of turbo-machines (by way of example gas turbines, compressors or even steam turbines), leakage gases can escape uncontrolled. Typical locations for the escape of leakage gases are component slots which are accessible in particular from the outside, but which have a fluid connection to the interior of the turbo-machine, if a leak is present. Thus it may happen by way of example that leakage gases escape to the outside from the interior of the turbo-machine through such component slots and cause damage there to the turbo-machine or to further functional components attached thereto. Thus by way of example hot gases emerging from a gas turbine can damage the fuel pipes, sensor systems or electronic systems attached to the outside surface of the housing, and also other temperature-sensitive components. At the same time, as a result of the escape of the hot gases a drop in power and performance takes place whereby a reduction in efficiency results throughout the entire turbo-machines.

In order to detect the leakage gases escaping from the turbo-machines, thermography cameras are typically used in order to detect changes in temperature or spreads in temperature over the surface of the turbo-machine. It is necessary here to remove the insulating layers enclosing the turbo-machine in order to be able to identify and localize the escape of the leakage gases.

The drawback with this method known from the prior art for localizing the escape sites is on the one hand the high technical expense since the insulation of the turbo-machine has to be removed in time-consuming work steps. During this work stringent safety measures have to be observed which has likewise proved disadvantageous. Since the escaping leakage gases can furthermore vary temporarily it can be difficult to establish a precise location of the escape site of the leakage gas from the turbo-machine at a specific measuring time point. Even if however the escape location can be determined it is in practice not possible with the method known from the prior art to quantify the leakage volume in order to establish the type and nature of the leak.

### SUMMARY OF INVENTION

Thus it has appeared technically necessary to propose a suitable turbo-machine which can overcome the drawbacks known from the prior art. More particularly a turbo-machine is to be proposed which allows the most accurately possible localization of the escape site of the leakage gases from the turbo-machine. It is furthermore to become possible to determine the volume of leakage gas over a specific observation time. These objects are to be fulfilled in particular without having to remove an outer insulation of the turbo-machine.

These objects on which the invention is based are achieved by a turbo-machine as well as by a method according to the claims.

More particularly the objects on which the invention is based are achieved by a turbo-machine having a plurality of component slots accessible from the outside wherein at least one section of a component slot is provided with a heat transfer line so that as the leakage gas escapes from the section of the component slot it interacts thermally with the heat transfer line wherein the thermal transfer line has a plurality of temperature sensors at different locations on the thermal transfer line and said temperature sensors are designed to detect temperature values on the thermal transfer line at the different locations.

The objects on which the invention is based are furthermore achieved by a method for operating a turbo-machine described above as well as below, wherein individual temperature values are determined simultaneously by means of the plurality of temperature sensors at the different locations of the thermal transfer line.

At this point it should be pointed out that component slots are to include all those component areas wherein at least two materially separated components are present. Typically component slots are formed at housing flanges, component seams and in general at those places where two components are in mechanical contact with one another.

It should furthermore be pointed out that the component slots according to the invention are to enable access from the outside. Components of a turbo-machine are then accessible externally unless it is necessary to remove components on the housing of the turbo-machine, after which by way of example first an inner flow chamber of the turbo-machine would become accessible. The external accessibility thus does not require opening or removing housing components in order to reach the component slots in question. Quite possibly however the removal of insulating material surrounding the turbo-machine may be necessary. More particularly all the components accessible at the housing outer wall of the turbo-machine are accessible externally.

Furthermore it is pointed out that the number of component slots accessible from outside or the number of temperature sensors at different locations of the heat transfer line can be one or a larger number.

According to the invention it is thus proposed that at least one section of a component slot of the turbo-machine is provided with a heat transfer line so that in the event of leakage gas escaping from the turbo-machine via the section of the component slot, the leakage gas which is typically very hot during operation of the turbo-machine can thermally interact with the heat transfer line. The interaction is hereby carried out in the region where the leakage gas is escaping whereby local heating of the thermal transfer line is the result. Since the thermal transfer line is fitted with a number of temperature sensors which are attached at different locations a suitable temperature distribution can be determined more particularly over the section of the component slot from the temperature values which are detected with the temperature sensors. As a result of the thermal conductivity of the thermal transfer line there is moreover a temporary change in the temperatures thus detected so that a time change profile can be established. Both from the locally distributed temperature values and also from the time-changing values, when knowing the thermal transfer properties of the thermal transfer line it is possible to deduce the location of the escape of leakage gas Likewise from the temporary distribution of the individual temperature values and from the amounts of the temperature values it is possible to deduce the volume of escaped leakage gas since this is proportional to the thermal energy transferred to the thermal transfer line.

More particularly by comparing individual measurements of the temperature values a temporary temperature gradient can be determined over the section of the component slot along the thermal transfer line from which it is possible to determine the location and volume of leakage gas. In this context it is more typically necessary that the different locations with temperature sensors are spaced from one another at defined intervals.

In other words it is necessary to know the intervals of the individual temperature sensors which remain constant in time in order to be able to deduce therefrom the location of the escape of leakage gas and/or the volume of escaped leakage gas when knowing the thermal conductivity of the thermal transfer line.

According to the invention it is possible in the event of leakage gas escaping from the component slots of a turbo-machine to establish without technical maintenance expense both the location of the escape and also the volume of leakage gas escaping. Removing an insulation around the turbo-machine is no longer necessary for this method, contrary to the method known from the prior art. Rather the method according to the invention is also suitable to be used underneath an insulating layer or cover and is thus also suitable for permanent operation.

As a result of determining the escape locations and escape volumes of leakage gas, suitable counter-measures can be purposefully taken in order to avoid consequential damage to further components attached to the housing outside wall of the turbo-machine.

According to a particular embodiment of the invention it is proposed that the thermal transfer line is formed as a fluid line in which a fluid is conveyed. When selecting suitable fluids which can be formed as cooling fluids by way of example, a good thermal transfer and thus also thermal expansion of the heat transferred to the thermal transfer line can be guaranteed. The fluid conveyed in the fluid line can be removed fluidically from the relevant region of the section of the component slot so that sensory evidence of the thermal transfer is required not solely in the region of the component slot. Rather in the case of the known flow control the thermal expansion in the fluid line can be easily replicated by model or program technology so that it is possible to purposefully deduce the escape location and escape volume of leakage gas from the heat profile inside the fluid line. Knowledge of the thermal properties of the fluid and its flow speed is necessary here.

According to a further development of this idea it is proposed that the fluid line is formed as a closed fluid line in which the fluid is moved during operation of the turbo-machine by means of a flow generator. A flow generator of this kind is designed by way of example as a pump which enables the fluid to move in the fluid line at a constant flow speed. The escape location and the escape volume of the leakage gas can thus be determined from the known flow speed and thermal transfer property of the fluid, and also from the detected temperature values.

According to a further advantageous embodiment of the invention it is proposed that the fluid line is in thermal interaction with a heat exchanger which is designed to cool the fluid in the fluid line. As a result of cooling the fluid a better temperature profile can be formed after detecting the temperature values via the temperature sensors since the differences in temperature of cooled fluid and also of fluid heated by leakage gas are greater. As a result of the better temperature profile thus formed along the fluid line it is possible to deduce with minimum error the escape location and escape volume of leakage gas from the section of the component slot. Similarly the cooling of the fluid in the fluid line permits a longer lasting operation since undesired thermal mixing during heating by the leakage gas over the entire fluid conveyed in the fluid line can be avoided.

According to a further embodiment of the invention it is proposed that the thermal transfer line is spaced from the section of the component slot by means of at least one spacer and is more particularly held by this spacer. The spacer thus guarantees a temporally constant spacing of the thermal transfer line from the component slot whereby smaller measuring errors are the result. Furthermore through the purposeful spacing a favorable operation of the turbo-machine can also be achieved for a permanent operation in the event of surrounding the housing outer side with insulating material. When surrounding the turbo-machine with insulating material it need not therefore be feared that the insulating material moves the thermal transfer line in an undesirable way or changes its position. The spacing of the thermal transfer line from the turbo-machine furthermore also guarantees preventing a direct thermal contact with the housing of the turbo-machine, whereby undesired false measurement results can be avoided. It is also possible to provide spacing or holding using a plurality of spacers, as can be easily understood.

According to a further development of this embodiment it can be proposed that the spacer is thermally insulated in respect of the housing of the turbo-machine. By way of example the spacer is made from a poor heat-conducting material such as by way of example ceramic. As a result of this thermal insulation thermal influences on the thermal transfer line can be further diminished whereby measuring errors can be reduced.

According to a further embodiment of the invention it is proposed that the different locations of the thermal transfer line with temperature sensors are evenly spaced from one another, more particularly are evenly spaced from one another over the section of the component slot. As a result of the even spacing all part-sections which are defined by adjacent temperature sensors can be treated the same in terms of evaluating the temperature values. A technically simplified evaluation is thus produced since the section or part-section fitted with uniformly mutually spaced temperature sensors can be divided up into regions of equal-sized length. For evaluation in this context more typically the temperature changes in the individual part-sections determined by adjacent temperature sensors are determined, and combined into one overview.

From this it is possible by way of example to determine a local temperature gradient along the thermal transfer line, and/or a time change of this gradient. From this in turn it is possible to determine by implication the escape location of leakage gas and the escape volume. Through the uniform spacing of the temperature sensors it is also possible to increase the reliability of the evidence since all component slot regions are provided substantially uniformly with temperature sensors.

According to a further advantageous embodiment of the turbo-machine according to the invention it is proposed that guide means are provided on the turbo-machine which in the event of leakage gas escaping from the section of the component slot guide the leakage gas to the thermal transfer line. Guide means of this kind are formed in particular as guide plates or as slot covers. According to the embodiment it is thus possible to guide the leakage gas specifically for the desired thermal transfer to the thermal transfer line. Furthermore it is also possible by means of these guide means to guide the leakage gas from the component slots to a thermal transfer line, in the case where the component slots are not arranged sufficiently close to the thermal transfer line. Thus by way of example leakage gas can escape from the relief slots of a component where as a result of the geometry of the relief slots the gas would not enter into thermal contact with the thermal transfer line. As a result of the guide means this leakage gas, which would otherwise be lost for evidence, can be guided to the thermal transfer line for efficient evidence.

According to a first embodiment of the method according to the invention for operating a turbo-machine it is proposed that the temporary thermal input into the thermal transfer line is determined at two mutually adjacent locations with temperature sensors. The temporary thermal input is determined by way of example in units of kJ/s. This determination is in particular undertaken for all part-sections of the section of the component slot which are determined by each two adjacent temperature sensors. As a result of determining the thermal input it is possible to determine not only a thermal profile along the thermal transfer line, but also to obtain concrete conclusions about the volume of escaped leakage gas. This makes it possible to establish a particularly efficient significant technical value for better characterizing the leakage.

The invention will now be explained in further detail below with reference to the individual figures. It is pointed out here that the figures are only to be understood diagrammatically and result in no limitation regarding the feasibility of the invention.

The components which are provided with identical reference numerals in the figures have identical technical effects.

Furthermore, it is to be noted that the technical features which are shown in the figures are claimed in any desired combination with one another, in so far as the combination can achieve the objects, on which the invention is based.

### BRIEF DESCRIPTION OF THE DRAWINGS

In the drawings:

FIG. 1 shows a side sectional view through components with component slot of a turbo-machine according to the invention according to a first embodiment of the invention;

FIG. 2 shows a diagrammatic circuit for determining a temperature profile along a section of a thermal transfer line according to a further embodiment of the turbo-machine according to the invention;

FIG. 3 shows a side sectional view through components with component slot according to a further embodiment of a turbo-machine according to the invention;

FIG. 4 shows a plan view of the embodiment of the components of the turbo-machine according to the invention shown in FIG. 3.

### DETAILED DESCRIPTION OF INVENTION

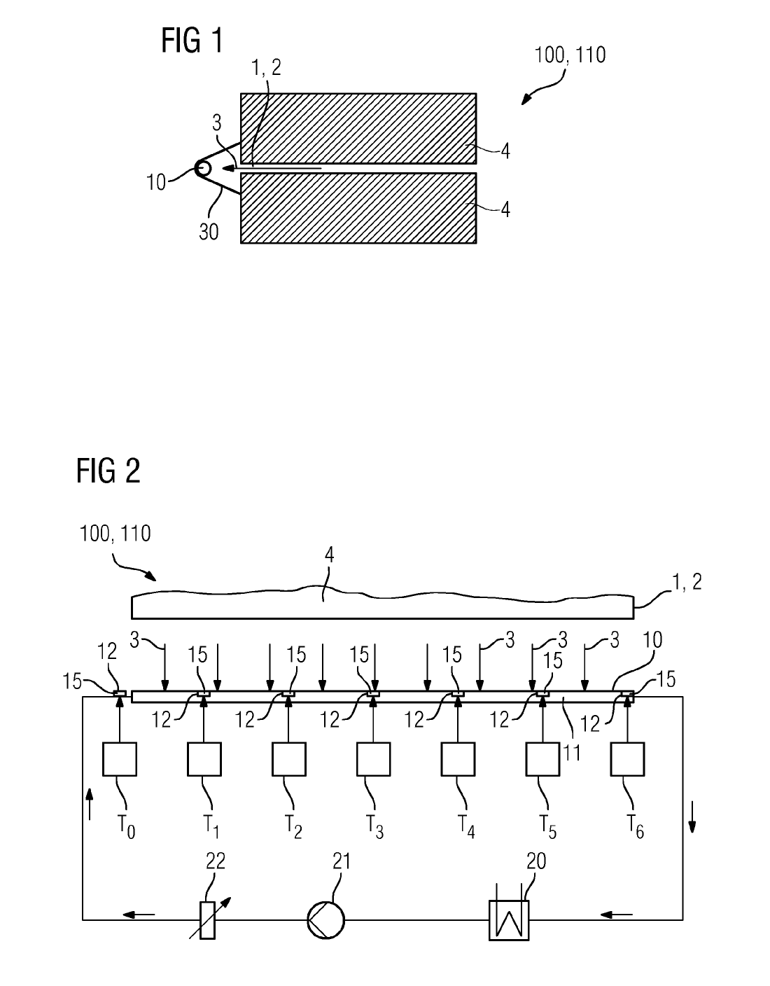

FIG. 1 shows a side sectional view through a first embodiment of the turbo-machine 100 according to the invention, wherein only components 4 of the housing 110 are shown by area. This is typically a housing join between two housing components. According to this design two mutually associated components 4 are provided which during fault-free operation of the turbo-machine allow no leakage gas to pass into the contact region of the two components 4. In the event of a fault however both components 4 can be locally spaced from one another so that leakage gas 3 can escape outwards between the two components 4. The escape direction of the leakage gas 3 is shown here by an arrow wherein the leakage gas 3 passes through a component slot 1 which is accessible from outside.

A thermal transfer line 10 is now arranged at a section 2 on this component slot 1 which is accessible from outside, this transfer line being spaced from the housing 110 by spacers 30 which are shown diagrammatically. The component slot 1 is thus provided with a thermal transfer line 10.

The spacers 30 are designed here so that in the event of a fault the leakage gas 3 escaping from the component slot can pass substantially undisturbed to the thermal transfer line 10 for thermal transfer.

As a result of the thermal transfer a local heating of the thermal transfer line 10 can arise which can be determined by a suitable arrangement of temperature sensors 15 (not shown here) both in respect of the location and also a temporary change in the thermal transfer. A possible circuit for determining the characteristic values which are to be detected is shown by way of example in FIG. 2.

According to the embodiment the thermal transfer line 10 is designed as a metallic wire which is spaced by about 1 cm from the section 2 of the component slot 1.

FIG. 2 shows a diagrammatic illustration of a further embodiment of the turbo-machine 100 according to the invention. As already explained with regard to the preceding embodiment, this embodiment also has a component slot 1 from which leakage gas 3 can escape in the event of a breakdown. The component slot 1 is again arranged in the region of two mutually contacting components 4 of a housing 110.

According to this design it is proposed that a thermal transfer line 10 is arranged on a section 2 of the component slot 1, this thermal transfer line 10 being designed as a fluid line 10 in which a fluid 11 is conveyed. The thermal transfer line 10 is designed as a cyclically closed fluid line. In order to impose a current on the fluid 11 in the thermal transfer line 10 a flow generator 21 is provided. A through-flow meter 22 is likewise provided in the thermal transfer line 10 and can detect the through-flow volume of fluid 11 in the fluid line 10.

A plurality of temperature sensors 15 (here seven temperature sensors in total) are provided over the section 2 of the component slot 1, and are arranged at different locations 12 of the thermal transfer line, each with a defined, more particularly identical, spacing from each other. If now as a result of a fault leakage gas escapes in the region of the section 2 of the component slot 1 this results in a thermal interaction of the leakage gas 3 with the fluid 11 in the thermal transfer line 10. Since the escape of leakage gas does not typically take place uniformly over all the regions of the section 2 of the component slot 1, many regions of the thermal transfer line 10 are heated up more severely than others. Consequently the thus more severely heated regions will result in a higher thermal input into the fluid 11 of the thermal transfer line 10. Thus a temperature profile is set overall along the thermal transfer line 10 over the section 2 of the component slot 1. The thermal profile can be detected here via temperature sensors 15 which are arranged approximately in the thermal transfer line 10 and measure the temperature of the fluid 11.

If now the temperature gradient between each two adjacent temperature sensors 15 is determined it is thus possible to identify that local region of the section 2 at which the highest temperature values are present, and thus also correspond with the highest leakage gas escape. If now the fluid 11 located in the thermal transfer line 10 is set into a uniform flow motion by means of the flow generator 21 there is a temporary change in the temperature profile identified by the temperature sensors 15. As a result of this temporary change and knowing the thermal conduction properties of the fluid 11 as well as the flow speed of the fluid 11 it is possible to deduce the volume of escaping leakage gas. The temporary behavior can be easily replicated by way of example by a physical model from which the desired values for the escape location and also the escape volume of leakage gas can be identified.

So that a determination can be made with the smallest possible error, it is desirable that the values detected by the temperature sensors deviate from one another over a wide temperature range. For only then can the most reliable possible temperature profile be established from the differential values.

Otherwise mixing of the fluid 11 in the thermal transfer line 10 is to be expected whereby a markedly flattened temperature profile results. In order to configure the measurements as definitely as possible the thermal transfer line 10 furthermore provides a heat exchanger 20 which is designed to cool the fluid 11 through thermal interaction. Thus by way of example it can be ensured that with a renewed inflow of the fluid 11 into the section 2 of the component slot 1 the fluid has a substantially lower temperature than at the location of the escape.

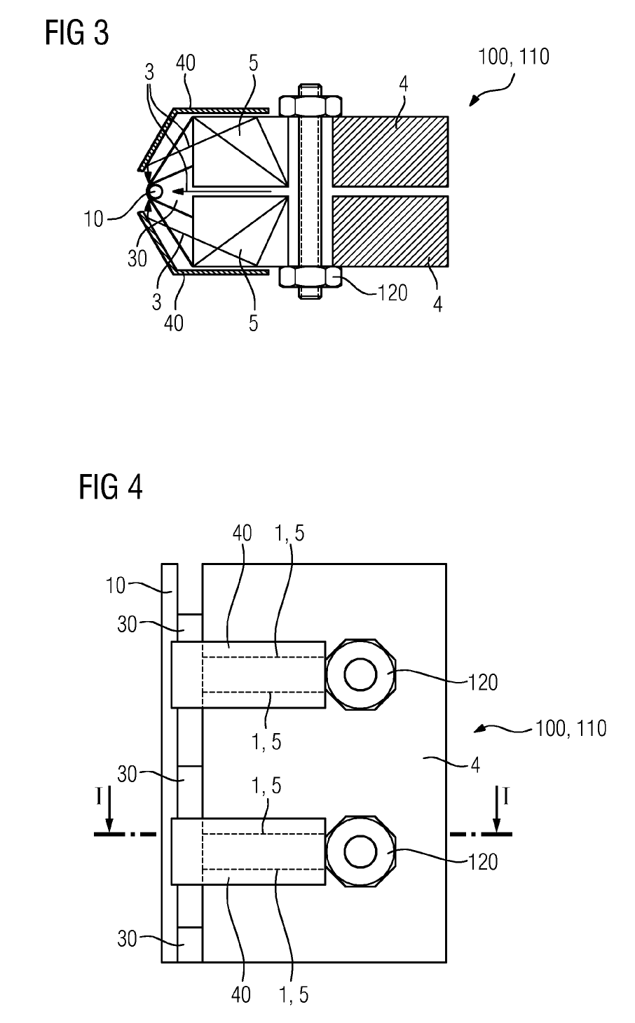

FIG. 3 shows a side sectional view through a further embodiment of a turbo-machine 100 according to the invention in a partial view. As already in the case of the embodiment according to FIG. 1 again only a partial area of two mutually contacting components 4 of a housing 110 is shown. However unlike the embodiment illustrated in FIG. 1, the present embodiment has a housing screw connection 120 which has suitable relief slots 5 in order to prevent tensions in the components 4. These relief slots are clearly seen in the plan view of FIG. 4.

As a result of the relief slots 5 which are required to avoid material tensions, in the event of a fault leakage gas 3 escaping between the two components 4 can be spread over a wider area without having to be directed to the thermal transfer line 10 however. In order to avoid a loss of escaping gas 3 in this way, according to this design two guide means 40 in the form of two suitably fitted guide plates are provided which supply the leakage gas purposefully to the thermal transfer line 10. It can consequently be guaranteed that the leakage gas can be suitably guided also in regions having several interconnected component slots in order to allow a good detection of the escape location and escape volume of leakage gas.

Further embodiments are apparent from the dependent claims.

1. A turbo-machine, comprising:
a plurality of component slots accessible from the outside,
at least one section of a component slot which is provided with a thermal transfer line such that in the event of leakage gas escaping from the section of the component slot it thermally interacts with the thermal transfer line,
wherein the thermal transfer line is provided with a plurality of temperature sensors at different locations on the thermal transfer line, which temperature sensors are designed to detect temperature values on the thermal transfer line at the different locations.

2. The turbo-machine as claimed in claim 1,
wherein the thermal transfer line is designed as a fluid line in which a fluid is guided.

3. The turbo machine as claimed in claim 2,
wherein the fluid line is a closed fluid line in which the fluid is moved by means of a flow generator during operation of the turbo-machine.

4. The turbo-machine as claimed in claim 2,
wherein the fluid line is in thermal interaction with a heat exchanger which is designed to cool the fluid in the fluid line.

5. The turbo-machine as claimed in claim 1,
wherein the thermal transfer line is spaced from the section of the component slot by means of at least one spacer.

6. The turbo-machine as claimed in claim 5,
wherein the spacer is thermally insulated from the housing of the turbo-machine.

7. The turbo-machine as claimed in claim 1,
wherein the different locations of the thermal transfer line having the temperature sensors are spaced uniformly from one another.

8. The turbo-machine as claimed in claim 1,
wherein guides are provided on the turbo-machine and in the event of leakage gas escaping from the section of the component slot guide the leakage gas to the thermal transfer line.

9. A method for operating a turbo-machine as claimed in claim 1,
wherein individual temperature values are identified simultaneously by means of the plurality of temperature sensors at the different locations on the thermal transfer line.

10. The method for operating a turbo-machine as claimed in claim 9,
wherein the temporary heat input into the thermal transfer line is determined at two mutually adjacent locations with temperature sensors.

11. The turbo-machine as claimed in claim 5,
wherein the thermal transfer line is held by means of the at least one spacer.

12. The turbo-machine as claimed in claim 7,
wherein the different locations of the thermal transfer line having the temperature sensors are spaced uniformly from one another over the section of the component slot.
